(19) United States
(12) Patent Application Publication
(10) Pub. No.: US 2011/0009572 A1
(43) Pub. Date: Jan. 13, 2011

(54) POLYMER BLENDS CONTAINING POLYDIORGANOSILOXANE UREA COPOLYMERS

(75) Inventors: Oliver Schaefer, Burghausen (DE); Mathias Scherer, Emmerting (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/919,407

(22) PCT Filed: Feb. 20, 2009
(86) PCT No.: PCT/EP09/52018

§ 371 Date: Aug. 30, 2010

(30) Foreign Application Priority Data
Feb. 29, 2008 (DE) 10 2008 000 465.0

(51) Int. Cl. C09J 183/04

(52) U.S. Cl. 525/452

(57) ABSTRACT

Polymer blends containing organopolysiloxane-polymer-polyurethane copolymers and thermoplastic polymers bearing epoxy, carboxylic acid, carboxylic acid ester, or carboxylic acid anhydride groups exhibit enhanced physical properties.

This invention concerns polymer blends of organopolysiloxane-polyurea-polyurethane copolymers and their use.

Silicones have excellent thermal, UV and weathering stabilities. They also retain their elastic properties at lower temperatures and therefore do not tend to become brittle either. They further have specific water-rejecting and antistick surface properties. Introducing functional groups into the silicone main chain as described in EP 0250248 for example gives materials that have thermoplastic properties. The thermoplastic silicones thus obtainable have excellent hydrophobic properties and outstanding breaking extensions and also a remarkable transparency, but also the disadvantage of a relatively inconvenient synthesis from costly starting materials and hence ultimately too costly for many applications. Some properties such as, for example, compression set and adherence are not sufficient in the case of the materials described in EP 0250248. These materials have simply been mixed with other thermoplastics in attempts to modify them and/or to make them more attractive in price, as well as to improve some properties of the thermoplastic materials. This is described inter alia in U.S. Pat. No. 6,846,893 and also in Yilgör et al.; Journal of Applied Polymer Science, Vol. 83, 1625-1634 and in Yilgör et al, Journal of Applied Polymer Science, Vol. 84, 535-540. Production of simple polymer blends did not result in sufficient compatibility between the various polymeric phases in the cases described.

Evidence for this is that the mechanical properties of the examples shown in U.S. Pat. No. 6,846,893 distinctly worsen on incorporation of the thermoplastic siloxane. Here the presence of the thermoplastic siloxane has an extremely unfavorable effect with regard to the mechanical parameters.

It is an object of the present invention to improve on the prior art, more particularly to provide a way of modifying the properties of the thermoplastic silicones in such a specific manner that improvements are obtained in respect of the bonding capacity and the breaking strength of the polymers in particular without, however, sacrificing other properties such as, for example, elastic behavior or the abhesive properties of the silicone surface.

The present invention accordingly provides a polymer mixture containing

a) an organopolysiloxane-polyurea-polyurethane copolymer (A) of general formula (1)

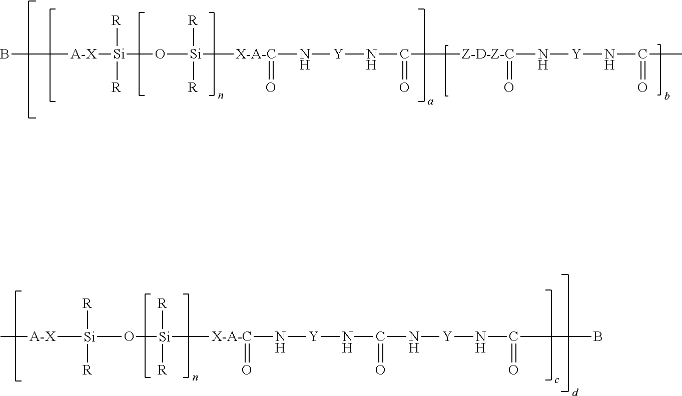

and
b) a thermoplastic polymer having a functional group selected from epoxy or carboxylic acid, carboxylic ester or carboxylic anhydride, and optionally
c) a nonreactive thermoplastic polymer,
wherein
R is a monovalent optionally fluorine- or chlorine-substituted hydrocarbyl radical having 1 to 20 carbon atoms,
X is a CR²₂ radical or an alkylene radical which has 1-20 carbon atoms and in which mutually nonadjacent methylene units may be replaced by —O— groups,
A is an oxygen atom or an amino group —NR′—,
Z is an oxygen atom or an amino group —NR′—,
R′ is hydrogen or an alkyl radical having 1 to 10 carbon atoms,
Y is a divalent optionally fluorine- or chlorine-substituted hydrocarbyl radical having 1 to 20 carbon atoms,
D is an alkylene radical of 1 to 700 carbon atoms which is optionally substituted by fluorine, chlorine, C₁-C₆-alkyl or C₁-C₆-alkyl ester and in which mutually nonadjacent methylene units may be replaced by —O—, —COO—, —OCO— or —OCOO— groups,
B is a functional or nonfunctional organic or organosilicon radical,
n is a number from 1 to 4000,
a is a number of at least 1,
b is a number from 0 to 100,
c is a number from 0 to 100, and
d is a number greater than 0.

The mixtures of the present invention are produced either in solution or without solvent. Preferably, however, without solvent, in the presence or absence of additives such as masticating aids for example. Production is either continuous or batchwise, but preferably continuous. Mixers or kneaders or extruders are used for this in accordance with the prior art. Mixing the individual components is preferably effected in already polymerized form, but can also be effected by adding the monomers and subsequent polymerization in the reactor in the presence of the other components.

The organopolysiloxane-polyurea-polyurethane copolymers are preferably produced in accordance with the prior art as described for example in EP 250248, EP 822951 or DE 10137855. Very particularly preferably as described in DE 10137855. The polydimethylsiloxane unit content of the organopolysiloxane-polyurea-polyurethane copolymers is preferably between 50% and 98% by weight and very particularly preferably between 70% and 96% by weight based on the weight of the organopolysiloxane-polyurea-polyurethane block copolymer. The proportion of the mixture which is attributable to the organopolysiloxane-polyurea-polyurethane copolymers is preferably between 5% and 90% by weight, more preferably 20-70% by weight and even more preferably between 40% and 60% by weight based on the weight of the total mixture of the polymer blend.

Thermoplastic polymers for the purposes of the invention are thermoplastic polymers having a functional group which are selected from epoxy or carboxylic acid, carboxylic ester or carboxylic anhydride. Preference here is given to selecting polymers having epoxy and carboxylic anhydride groups and very particularly preferably polymers having carboxylic anhydride groups. The proportion of the thermoplastic material b) which is attributable to this functional group is preferably between 0.1% and 40% by weight, more preferably between 0.1% and 15% by weight and even more preferably between 0.3% and 10% by weight based on the weight of the thermoplastic material b). The proportion of the mixture which is attributable to the reactive thermoplastic is preferably between 5% and 95% by weight, more preferably between 5% and 80% by weight and even more preferably between 5% and 60% by weight, based on the weight of the entire polymer blend. Preference here is given to using copolymers of ethylenically unsaturated compounds such as, for example, ethylene, propylene, butadiene, isoprene, vinyl acetate, esters of acrylic acid and/or methacrylic acid, styrene, vinyl chloride, glycidyl methacrylate, maleic anhydride, acrylic acid or methacrylic acid. These are endowed with the above-described functional groups either directly by copolymerization of appropriate monomers such as, for example, glycidyl methacrylate, maleic anhydride, acrylic acid or methacrylic acid having the appropriate functional groups, or else subsequently by polymer-analogous reactions such as, for example, epoxidation reactions, particular preference being given to a methacrylic anhydride copolymer. Examples of such thermoplastics of the present invention are products of the LOTADER® family, products of the OREVAC® family, or products of the ADMER® family.

The present invention further provides a process for producing a polymer mixture wherein a) an organopolysiloxane-polyurea-polyurethane block copolymer (A) and b) a thermoplastic polymer having a functional group and optionally

c) a nonreactive thermoplastic polymer are mixed.

The amounts and descriptions for an organopolysiloxane-polyurea-polyurethane block copolymer (A) and b) a thermoplastic polymer having a functional group and optionally

c) a nonreactive thermoplastic polymer are described above.

In the process of the present invention for producing a polymer mixture, mixing takes place at a temperature of preferably 30° C. to 240° C., more preferably at 150° C. to 220° C.

In addition, the polymer blends of the present invention may preferably further contain between 0% and 70% by weight, based on the weight of the entire polymer mixture, of nonreactive polymers such as, for example, polyesters, polyamides, polyolefins, halogenated polyolefins, polyacrylates or polymethacrylates, styrene-acrylonitrile copolymers, polycarbonates, polyvinyl acetates or polyvinyl acetate-ethylene copolymers.

It was found that, surprisingly, the use of polymers having chemical reactivity in relation to urea, urethane or amide function provides a distinct optimization in the property portfolio.

The polymer blends of the present invention have excellent properties with regard to adherence and low-temperature elasticity in injection molding applications for, for example, the electronic and medical sectors, or in extrusion applications for fibers or industrial film/sheeting.

Preferred applications for the polymer mixtures of the present invention are uses as a constituent in adhesives and sealants, as a base material for thermoplastic elastomers such as for example cable sheathing, hoses, seals, keyboard mats, for membranes, such as selectively gas-permeable membranes, for coating applications for example in antistick coatings, tissue-compatible coatings, flame-retardant coatings and as biocompatible materials, as processing assistants in thermoplastic extrusion and in the extrusion of fiber composite materials of construction. Further application possibilities are sealants, additives for polymer processing, anti-fouling coatings, cosmetics, personal care agents, paint additives, auxiliary in laundry detergents and textile processing, for modifying resins or for bitumen modification, as a plastics additive for example as impact modifier or flame retardant, as a material for defoamer formulations, as a packaging material for electronic components, in insulation or shielding materials, in cable sheathing, as an additive for scouring, cleaning or polishing products, as an additive for personal care agents, as a coating material for wood, paper and paperboard, as a demolding agent, as a coating material for textile fibers or textile fabrics, as a coating material for natural substances such as, for example, leather and furs, as a material for membranes and as a material for photoactive systems, for example for lithographic processes, optical data securement or optical data transmission.

All the above symbols in the above formulae each have their meanings independent of each other.

In the examples hereinbelow, unless particularly stated otherwise, all amounts and percentages are by weight and all pressures are 0.10 MPa (abs.). Softening ranges were determined via TMA.

### INVENTIVE EXAMPLE 1

A twin-screw kneader from Collin, Ebersberg, having 6 heating zones and one devolatilizing zone was charged with a mixture of 60% by weight of GENIOMER 80, WACKER CHEMIE AG (polysiloxane-urea copolymer, molecular weight Mw=135 000 daltons) and 40% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 140° C., zone 3 170° C., zone 4 185° C., zone 5 185° C., zone 6 175° C. Rotary speed was 120 rpm. At the extruder die, a polydimethylsiloxane-polyurea copolymer/terpolymer blend was withdrawn and cooled and pelletized in a water bath.

### INVENTIVE EXAMPLE 2

A twin-screw kneader from Collin, Ebersberg, having 6 heating zones and one devolatilizing zone was charged with a mixture of 60% by weight of GENIOMER 140, WACKER CHEMIE AG (polysiloxane-urea copolymer, molecular weight Mw=65 000 daltons) and 40% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 140° C., zone 3 170° C., zone 4 190° C., zone 5 190° C., zone 6 175° C. Rotary speed was 120 rpm. At the extruder die, a polydimethylsiloxane-polyurea copolymer/terpolymer blend was withdrawn and cooled and pelletized in a water bath.

### INVENTIVE EXAMPLE 3

A twin-screw kneader from Collin, Ebersberg, having 6 heating zones and one devolatilizing zone was charged with a mixture of 60% by weight of GENIOMER 60, WACKER CHEMIE AG (polysiloxane-urea copolymer, molecular weight Mw=85 000 daltons) and 40% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 110° C., zone 3 120° C., zone 4 140° C., zone 5 140° C., zone 6 135° C. Rotary speed was 120 rpm. At the extruder die, a polydimethylsiloxane-polyurea copolymer/terpolymer blend was withdrawn and cooled and pelletized in a water bath.

### INVENTIVE EXAMPLE 4

A twin-screw kneader from Collin, Ebersberg, having 6 heating zones and one devolatilizing zone was charged with a mixture of 60% by weight of GENIOMER 200/70, WACKER CHEMIE AG (polysiloxane-urea copolymer, molecular weight Mw=165 000 daltons) and 40% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 140° C., zone 3 180° C., zone 4 190° C., zone 5 190° C., zone 6 175° C. Rotary speed was 120 rpm. At the extruder die, a polydimethylsiloxane-polyurea copolymer/terpolymer blend was withdrawn and cooled and pelletized in a water bath.

### INVENTIVE EXAMPLE 5

A twin-screw kneader from Collin, Ebersberg, having 6 heating zones and one devolatilizing zone was charged with a mixture of 60% by weight of GENIOMER 200/50, WACKER CHEMIE AG (polysiloxane-urea copolymer, molecular weight Mw=143 000 daltons) and 40% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 140° C., zone 3 180° C., zone 4 190° C., zone 5 190° C., zone 6 175° C. Rotary speed was 120 rpm. At the extruder die, a polydimethylsiloxane-polyurea copolymer/terpolymer blend was withdrawn and cooled and pelletized in a water bath.

### INVENTIVE EXAMPLE 6

A twin-screw kneader from Collin, Ebersberg, having 6 heating zones and one devolatilizing zone was charged with a mixture of 40% by weight of GENIOMER 80, WACKER CHEMIE AG (polysiloxane-urea copolymer, molecular weight Mw=135 000 daltons) 50% by weight of Lupolen 3020 H (Basell) and 10% by weight of LOTADER 4403 from ARKEMA (ethylene-methacrylic ester-methacrylic anhydride copolymer with 0.3% methacrylic anhydride fraction) (=terpolymer), followed by compounding at elevated temperature. The temperature profile of the heating zones was programmed as follows: zone 1 40° C., zone 2 140° C., zone 3 170° C., zone 4 185° C., zone 5 185° C., zone 6 175° C. Rotary speed was 120 rpm. At the extruder die, a polydimethylsiloxane-polyurea copolymer-/terpolymer blend was withdrawn and cooled and pelletized in a water bath.

### COMPARATIVE EXAMPLE 1

A twin-screw kneader from Collin, Ebersberg, having 6 heating zones and one devolatilizing zone was charged with a mixture of 60% by weight of GENIOMER 140, WACKER CHEMIE AG (polysiloxane-urea copolymer) and 40% by weight of Lupolen 3020 from Basell (LDPE with 0.0% methacrylic anhydride fraction) followed by compounding at elevated temperature. The temperature profile of the heating zones was programmed as follows: zone 1 40° C., zone 2 140° C., zone 3 180° C., zone 4 190° C., zone 5 195° C., zone 6 185° C. Rotary speed was 120 rpm. At the extruder die, a polydimethylsiloxane-polyurea copolymer/LDPE blend was withdrawn and cooled and pelletized in a water bath.

### COMPARATIVE EXAMPLE 2

A twin-screw kneader from Collin, Ebersberg, having 6 heating zones and one devolatilizing zone was charged with a 100% by weight of GENIOMER 80, WACKER CHEMIE AG (polysiloxane-urea copolymer) followed by compounding at elevated temperature. The temperature profile of the heating zones was programmed as follows: zone 1 40° C., zone 2 140° C., zone 3 180° C., zone 4 180° C., zone 5 185° C., zone 6 175° C. Rotary speed was 120 rpm. At the extruder die, a polydimethylsiloxane-polyurea copolymer was withdrawn and cooled and pelletized in a water bath.

Determination of Mechanical Properties:

| | | | | Break- | | |
|---|---|---|---|---|---|---|
| | Polymer | Polymer | Breaking | ing ex- | Shore | |
| Example | 1 | 2 | strength | tension | A | Color |
| Inventive | Geniomer | Lotader | 6.7 MPa | 600% | 62 | white |
| 1 | 80 | 4403 | | | | |
| Inventive | Geniomer | Lotader | 9.9 MPa | 640% | 68 | white |
| 2 | 140 | 4403 | | | | |
| Inventive | Geniomer | Lotader | 7.1 MPa | 653% | 75 | white |
| 3 | 60 | 4403 | | | | |
| Inventive | Geniomer | Lotader | 5.0 MPa | 510% | 70 | white |
| 4 | 200/70 | 4403 | | | | |
| Inventive | Geniomer | Lotader | 3.2 MPa | 560% | 48% | white |
| 5 | 200/50 | 4403 | | | | |
| Compar- | Geniomer | Lupolen | 1.3 MPa | 155% | 63 | white |
| ative 1 | 140 | 3020 | | | | |
| Compar- | Geniomer | — | 4.4 MPa | 463% | 53 | trans- |
| ative 2 | 140 | | | | | parent |

| | | | | Tear |
|---|---|---|---|---|
| | Polymer | Polymer | Rebound | strength |
| Example | 1 | 2 | elasticity | [N/mm] |
| Inventive | Geniomer | Lotader | 46% | 25.91 |
| 1 | 80 | 4403 | | |
| Inventive | Geniomer | Lotader | 51% | 31.26 |
| 2 | 140 | 4403 | | |
| Inventive | Geniomer | Lotader | 42% | 31.48 |
| 3 | 60 | 4403 | | |
| Inventive | Geniomer | Lotader | 45% | 28.21 |
| 4 | 200/70 | 4403 | | |
| Inventive | Geniomer | Lotader | 44% | 22.31 |
| 5 | 200/50 | 4403 | | |
| Compar- | Geniomer | Lupolen | 47% | <10 |
| ative 1 | 140 | 3020 | | |
| Compar- | Geniomer | — | 62% | 25.30 |
| ative 2 | 140 | | | |

Determination of Melt Viscosities

High pressure capillary viscometer from Göttfert, nozzle 30*2 mm

| Example | Temperature | 10 l/s | 100 l/s | 1000 l/s |
|---|---|---|---|---|
| Inventive 1 | 180 | 2649 | 823 | 207 |
| Inventive 2 | 180 | 4645 | 1596 | 326 |
| Inventive 3 | 140 | 3912 | 1185 | 310 |
| Inventive 4 | 180 | 244 | 86 | 42 |
| Comparative 2 | 170 | 2815 | 765 | 321 |

It can be seen that the various polymer mixtures display different processing characteristics and that incorporation of the functional thermoplastic slightly increases melt viscosity (Inventive Example 1 compared with Comparative Example 2).

Determination of Rub-off Properties

The materials produced under Inventive Examples 1 and 2 and Comparative Example 1 were extruded to form a film about 100 μm in thickness, which was ironed onto a woven polyamide fabric.

| | Number of | |
|---|---|---|
| Example | scrubs | Color |
| Inventive 6 | 350 | white |
| Inventive 2 | 250 | white |
| Comparative 1 | 100 | white |

Determination of Adherence

The materials produced under Inventive Examples 3 and 4 and Comparative Example 2 were extruded to form a sheet about 300 μm in thickness, which was placed between two PP sheets (500 μm) and the sandwich was subsequently molded together at 150° C. under a pressure of 5 bar for 15 minutes. Adherence was subsequently tested in a peel test by peeling off the material at an angle of 180°.

| Example | PP sheet |
|---|---|
| Inventive 1 | >3 N/mm |
| Inventive 2 | >3 N/mm |
| Inventive 3 | >3 N/mm |
| Inventive 4 | >3 N/mm |
| Comparative 1 | <1 N/mm |

1.-9. (canceled)

10. A polymer mixture containing
a) an organopolysiloxane-polyurea-polyurethane copolymer (A) of formula (1) 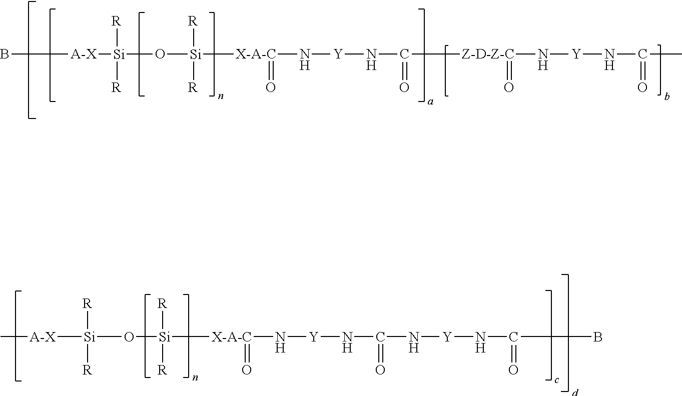
and
b) a thermoplastic polymer having at least one functional group selected from the group consisting of epoxy, carboxylic acid, carboxylic ester, and carboxylic anhydride, and
c) optionally a nonreactive thermoplastic polymer,
wherein
R is a monovalent optionally fluorine- or chlorine-substituted hydrocarbyl radical having 1 to 20 carbon atoms,
X is a CR²₂ radical or an alkylene radical which has 1-20 carbon atoms and in which nonadjacent methylene units may be replaced by —O— groups,
A is an oxygen atom or an amino group —NR′—,
Z is an oxygen atom or an amino group —NR′—,
R′ is hydrogen or an alkyl radical having 1 to 10 carbon atoms,
Y is a divalent optionally fluorine- or chlorine-substituted hydrocarbyl radical having 1 to 20 carbon atoms,
D is an alkylene radical of 1 to 700 carbon atoms which is optionally substituted by fluorine, chlorine, C₁-C₆-alkyl or C₁-C₆-alkyl ester and in which nonadjacent methylene units may be replaced by —0—, —COO—, —OCO— or —OCOO— groups,
B is a functional or nonfunctional organic or organosilicon radical,
n is a number from 1 to 4000,
a is a number of at least 1,
b is a number from 0 to 100,
c is a number from 0 to 100, and
d is a number greater than 0.

11. The polymer mixture of claim 10, wherein the organopolysiloxane-polyurea-polyurethane copolymer has a content of polydimethylsiloxane units between 50% and 98% by weight, based on the total weight of the copolymer.

12. The polymer mixture of claim 10, wherein the proportion of the organopolysiloxane-polyurea-polyurethane copolymer in the mixture is between 5% and 90% by weight, based on the total weight of the polymer mixture.

13. The polymer mixture of claim 11, wherein the proportion of the organopolysiloxane-polyurea-polyurethane copolymer in the mixture is between 5% and 90% by weight, based on the total weight of the polymer mixture.

14. The polymer mixture of claim 10, wherein the proportion of functional groups in the thermoplastic polymer b) is between 0.1% and 40% by weight, based on the weight of the thermoplastic polymer b).

15. The polymer mixture of claim 11, wherein the proportion of functional groups in the thermoplastic polymer b) is between 0.1% and 40% by weight, based on the weight of the thermoplastic polymer b).

16. The polymer mixture of claim 12, wherein the proportion of functional groups in the thermoplastic polymer b) is between 0.1% and 40% by weight, based on the weight of the thermoplastic polymer b).

17. The polymer mixture of claim 13, wherein the proportion of functional groups in the thermoplastic polymer b) is between 0.1% and 40% by weight, based on the weight of the thermoplastic polymer b).

18. The polymer mixture of claim 10, wherein the proportion of thermoplastic polymer b) in the mixture is between 5% and 95% by weight, based on the weight of the polymer mixture.

19. The polymer mixture of claim 11, wherein the proportion of thermoplastic polymer b) in the mixture is between 5% and 95% by weight, based on the weight of the polymer mixture.

20. The polymer mixture of claim 12, wherein the proportion of thermoplastic polymer b) in the mixture is between 5% and 95% by weight, based on the weight of the polymer mixture.

21. A process for producing the polymer mixture of claim 10, comprising mixing a) an organopolysiloxane-polyurea-polyurethane copolymer (A) and b) a thermoplastic polymer having a functional group and c) optionally a nonreactive thermoplastic polymer.

22. The process of claim 21, wherein mixing is carried out at a temperature of 30° C. to 240° C.

23. An adhesive, sealant, molded article or additive, comprising at least one polymer mixture of claim 10.

24. An abhesive layer or coextrudate having an abhesive layer, wherein the abhesive layer includes at least one polymer mixture of claim 10.
